(19) United States
(12) Patent Application Publication
(10) Pub. No.: US 2025/0226615 A1
(43) Pub. Date: Jul. 10, 2025

(54) Cable Fixing Device, Connector Housing Assembly and Connector

(71) Applicants: Tyco Electronics (Suzhou) Ltd., Suzhou City (CN); Tyco Electronics (Shanghai) Ltd., Shanghai (CN)

(72) Inventors: Zhihui (Vito) Tang, Suzhou (CN); Feng (Charles) Wan, Shanghai (CN); Zhaowen Zhou, Shanghai (CN)

(73) Assignees: Tyco Electronics (Suzhou) Ltd., Suzhou City (CN); Tyco Electronics (Shanghai) Ltd., Shanghai (CN)

(21) Appl. No.: 19/009,188

(22) Filed: Jan. 3, 2025

(30) Foreign Application Priority Data
Jan. 5, 2024 (CN) 202420027159.1

(51) Int. Cl. H01R 13/639; H01R 12/59; H01R 13/502; H01R 107/00

(52) U.S. Cl. CPC H01R 13/639; H01R 12/59; H01R 13/502; H01R 2107/00

(57) ABSTRACT

A cable fixing device includes a fixing component having a plurality of cable holes and a slot transversely running through the plurality of cable holes, and a locking component having a plurality of slot holes corresponding to the plurality of cable holes. The locking component is inserted into the slot of the fixing component and is movable between a pre-lock position and a final-lock position. One of the slot holes aligns with one of the cable holes and a cable is passable through the one of the cable holes and the one of the slot holes in the pre-lock position. The one of the slot holes is offset from the one of the cable holes in the final-lock position and an inner wall surface of the one of the slot holes presses against the cable passing through the one of the cable holes to lock the cable.

### CROSS-REFERENCE TO RELATED APPLICATIONS

This application claims the benefit of the filing date under 35 U.S.C. § 119 (a)-(d) of Chinese Patent Application No. 202420027159.1, filed on Jan. 5, 2024.

### FIELD OF THE INVENTION

The present invention relates to a cable fixing device, a connector housing assembly comprising the cable fixing device, and a connector comprising the connector housing assembly.

### BACKGROUND OF THE INVENTION

Cables of a connector are commonly tied and fixed with a zip tie or secured with a seal and a specialized cable clamp. However, the zip tie is usually only used to tie and secure single row cables, and is not suitable for securing multiple rows and columns of cables. Using a seal and a specialized cable clamp for multiple cables, however, increases costs.

### SUMMARY OF THE INVENTION

A cable fixing device includes a fixing component having a plurality of cable holes and a slot transversely running through the plurality of cable holes, and a locking component having a plurality of slot holes corresponding to the plurality of cable holes. The locking component is inserted into the slot of the fixing component and is movable between a pre-lock position and a final-lock position. One of the slot holes aligns with one of the cable holes and a cable is passable through the one of the cable holes and the one of the slot holes in the pre-lock position. The one of the slot holes is offset from the one of the cable holes in the final-lock position and an inner wall surface of the one of the slot holes presses against the cable passing through the one of the cable holes to lock the cable.

### BRIEF DESCRIPTION OF DRAWINGS

The invention will now be described by way of example with reference to the accompanying figures, of which:

FIG. 1 is an exploded view of a connector according to an exemplary embodiment;

FIG. 2 is a perspective view of the connector of FIG. 1;

FIG. 3 is a sectional perspective view of the connector of FIG. 1;

FIG. 4 is a perspective view of a cable fixing device of a connector housing assembly of the connector of FIG. 1 according to an embodiment;

FIG. 5 is an exploded view of the cable fixing device of FIG. 4;

FIG. 6 is a sectional exploded view of the cable fixing device of FIG. 4;

FIG. 7 is a sectional view of a locking component of the cable fixing device of FIG. 4 in a pre-lock position according to an embodiment;

FIG. 8 is a sectional view of a cable passing through the cable fixing device of FIG. 4 and the locking component of FIG. 7 in a pre-lock position;

FIG. 9 is a sectional view of the connector of FIG. 1 in the pre-lock position;

FIG. 10 is a sectional view of the cable fixing device of FIG. 4 having the locking component of FIG. 7 in a final-lock position;

FIG. 11 is a sectional view of a cable passing through the cable fixing device of FIG. 4 and the locking component of FIG. 7 in the final-lock position; and

FIG. 12 is a sectional view of the connector of FIG. 1 with the locking component of FIG. 7 in the final-lock position.

### DETAILED DESCRIPTION

Exemplary embodiments of the present disclosure will be described hereinafter in detail with reference to the attached figures, wherein like reference numerals refer to like elements. The present disclosure may, however, be embodied in many different forms and should not be construed as being limited to the embodiments set forth herein; rather, these embodiments are provided so that the present disclosure will convey the concept of the disclosure to those skilled in the art.

In the following detailed description, for purposes of explanation, numerous specific details are set forth in order to provide a thorough understanding of the disclosed embodiments. It will be apparent, however, that one or more embodiments may be practiced without these specific details. In other instances, well-known structures and devices are schematically shown in order to simplify the figure(s).

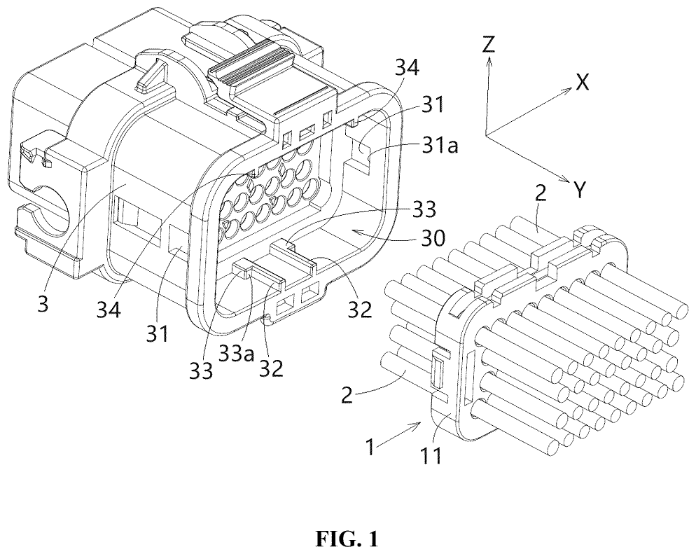

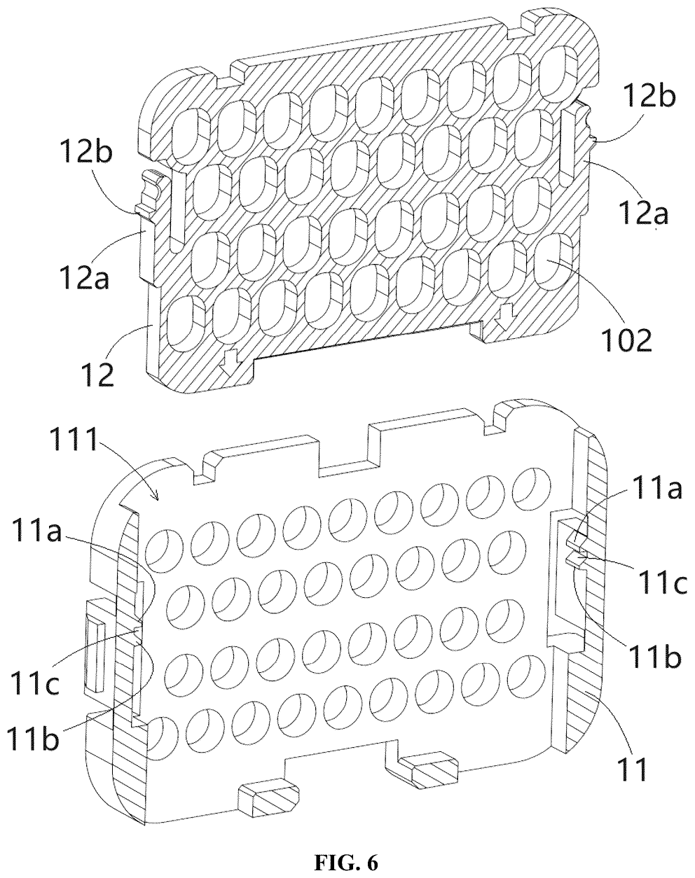

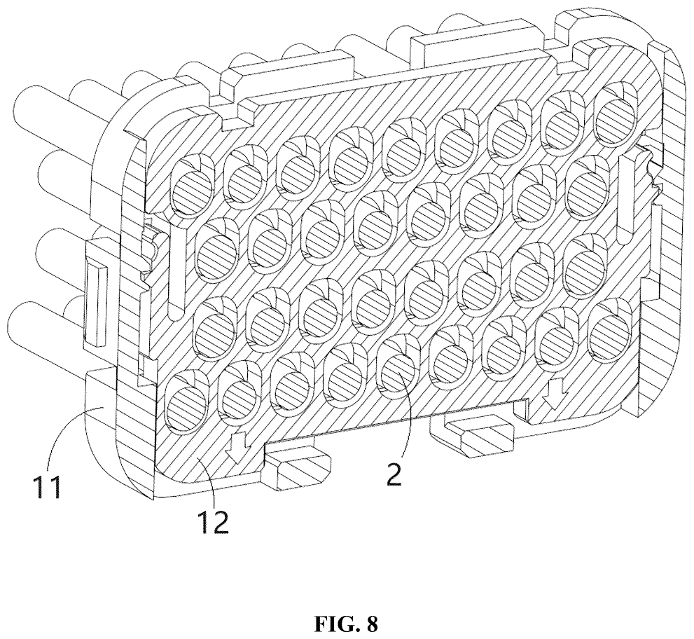

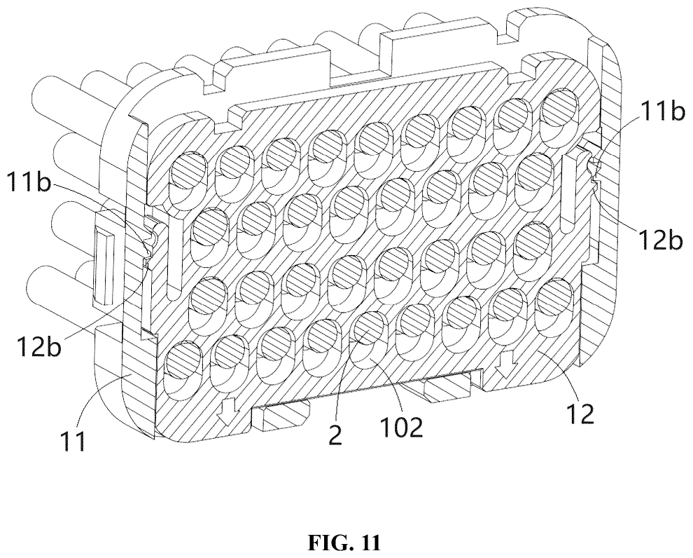

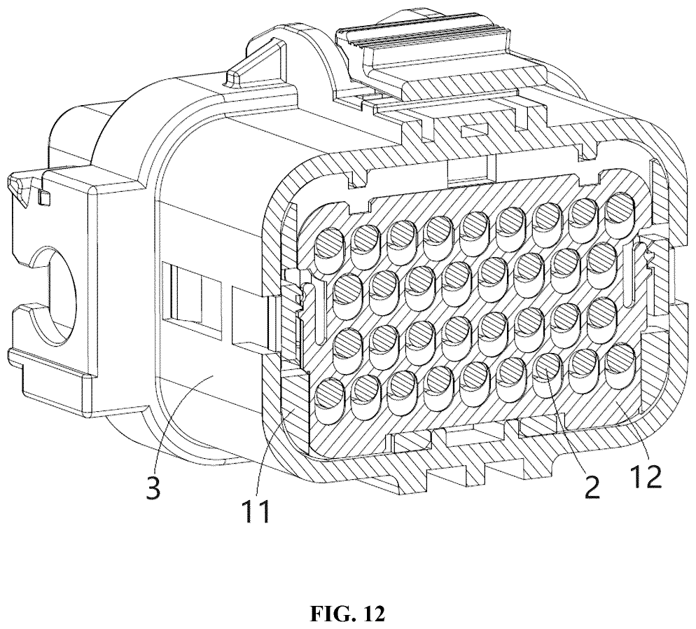

A connector according to an embodiment shown in FIGS. 1-12 is now described. The connector comprises a connector housing assembly, multiple terminals, and multiple cables 2. The connector housing assembly comprises a cable fixing device 1.

The cable fixing device 1, as shown in FIGS. 1-12, includes a fixing component 11 and a locking component 12. Multiple cable holes 101 and a slot 111 transversely penetrating through the multiple cable holes 101 are formed in the fixing component 11. The locking component 12 is inserted into the slot 111 of the fixing component 11 and formed with multiple slot holes 102 corresponding to the multiple cable holes 101.

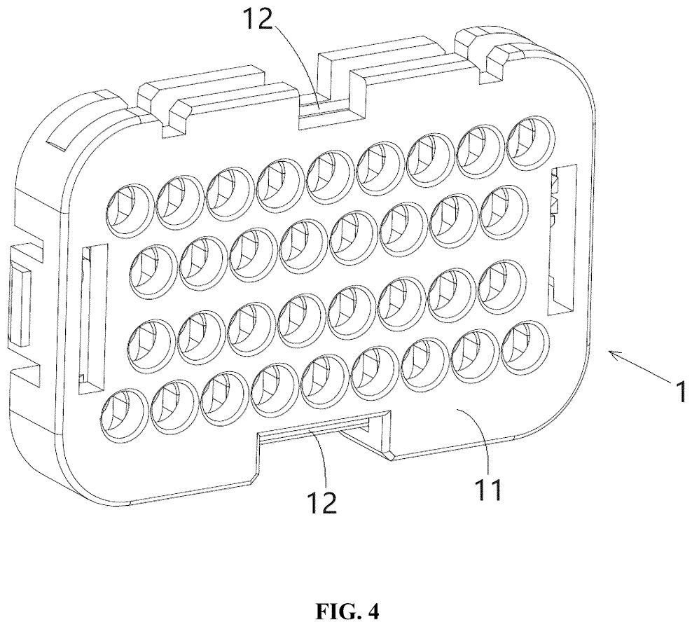

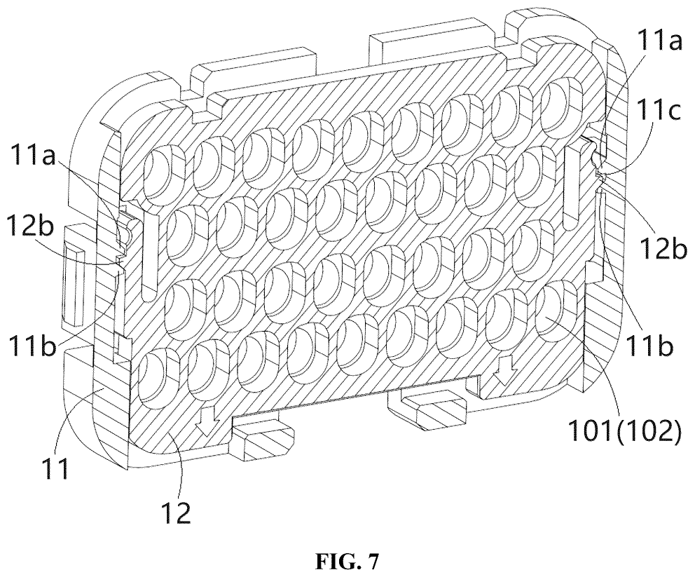

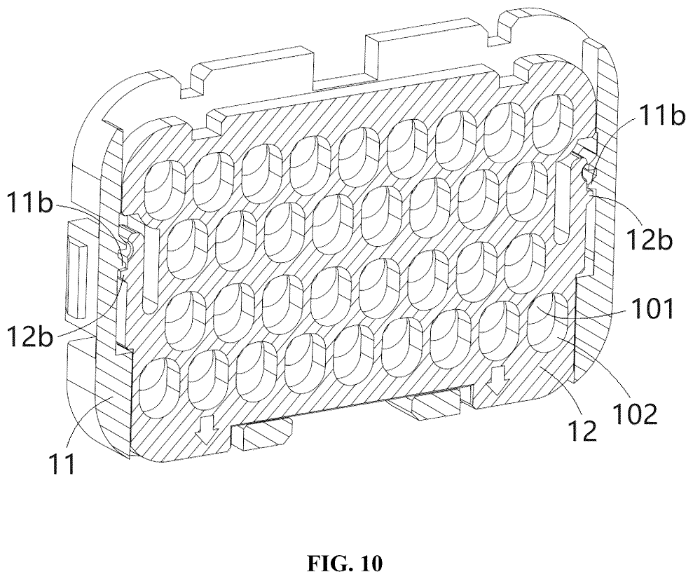

As shown in FIGS. 4-12, in the illustrated embodiment, the locking component 12 is inserted into the slot 111 in a movable manner, and can be moved between a pre-lock position (position shown in FIGS. 7-9) and a final-lock position (position shown in FIGS. 10-12).

As shown in FIGS. 7-9, in the illustrated embodiment, when the locking component 12 is in the pre-lock position, the slot hole 102 aligns with the cable hole 101 to allow the cable 2 to pass through both the cable hole 101 and the slot hole 102.

As shown in FIGS. 10-12, in the illustrated embodiment, when the locking component 12 is in the final-lock position, the slot hole 102 is offset from the cable hole 101 and an inner wall surface of the slot hole 102 is pressed against the cable 2 passing through the cable hole 101 to lock the cable 2.

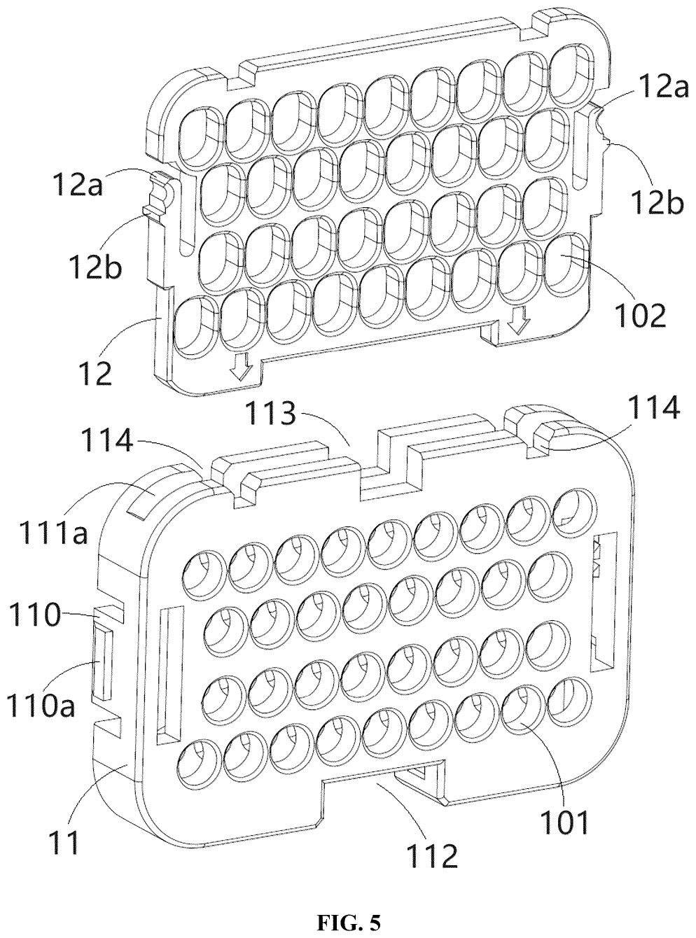

As shown in FIGS. 1, 5, 7, and 10, in the illustrated embodiment, the fixing component 11 and the locking component 12 have opposite upper and lower sides in a first direction (vertical direction in the figure) Z, which is perpendicular to the axial direction Y of the cable hole 101. The slot 111, as shown in FIG. 5, has an upper opening 111a located on the upper side of the fixing component 11, and the locking component 12 is inserted into the slot 111 along the first direction Z through the upper opening 111a.

As shown in FIGS. 1, 5, 7, and 10, in the illustrated embodiment, the fixing component 11 and the locking component 12 have opposite left and right sides in a second direction X perpendicular to the first direction Z and the axial direction Y of the cable hole 101. Elastic buckles 12a with locking protrusions 12b, as shown in FIGS. 5-7 and 10-11, are respectively formed on the left and right sides of the locking component 12. A first protrusion 11a, a second protrusion 11b, and a snap slot 11c located between the first protrusion 11a and second protrusions 11b are formed on the left and right sides of the slot 111 of the fixing component 11, respectively.

As shown in FIGS. 7-9, in the illustrated embodiment, when the locking component 12 is in the pre-lock position, the locking protrusion 12b on the elastic buckle 12a engages with the snap slot 11c to hold the locking component 12 in the pre-lock position.

As shown in FIGS. 10-12, in the illustrated embodiment, when the locking component 12 is in the final-lock position, the locking protrusion 12b on the elastic buckle 12a engages with the second protrusion 11b to hold the locking component 12 in the final-lock position.

As shown in FIGS. 1, 5-7, and 10-11, in the illustrated embodiment, the slot hole 102 on the locking component 12 is elliptical in shape and a size of the slot hole 102 in the first direction Z is larger than its size in the second direction X. A diameter of the cable hole 101 is equal to or slightly larger than a diameter of the cable 2, and the size of the slot hole 102 in the second direction X is equal to or slightly larger than the diameter of the cable 2.

As shown in FIGS. 1-3, 9, and 12, in the illustrated embodiment, the fixing component 11 is adapted to be installed into an installation port 30 of a housing 3 of the connector housing assembly. Elastic locking buckles 110 with protruding portions 110a are formed on the left and right sides of the fixing component 11, respectively. The protruding portions 110a of the elastic locking buckles 110 are adapted to engage with the locking slots 31 on the housing 3 to lock the fixing component 11 into the installation port 30 of the housing 3.

As shown in FIG. 5, in the illustrated embodiment, upper slots 113 and lower slots 112 are respectively formed on the upper and lower sides of the fixing component 11 to allow the insertion of an operating tool, so that the locking component 12 can be pushed from the pre-lock position, shown in FIGS. 7-9, to the final-lock position, shown in FIGS. 10-12, by the operating tool inserted into the upper slot 113 or from the final-lock position to the pre-lock position by the operating tool inserted into the lower slot 112.

As shown in FIGS. 1 and 5, in the illustrated embodiment, the two inner sides of the lower slot 112 of the fixing component 11 are perpendicular to the second direction X and are adapted to rest on the outer sides of a pair of lower guide ribs 32 of the housing 3, to guide the fixing component 11 to be inserted into the installation port 30 of the housing 3 along the axial direction Y of the cable hole 101.

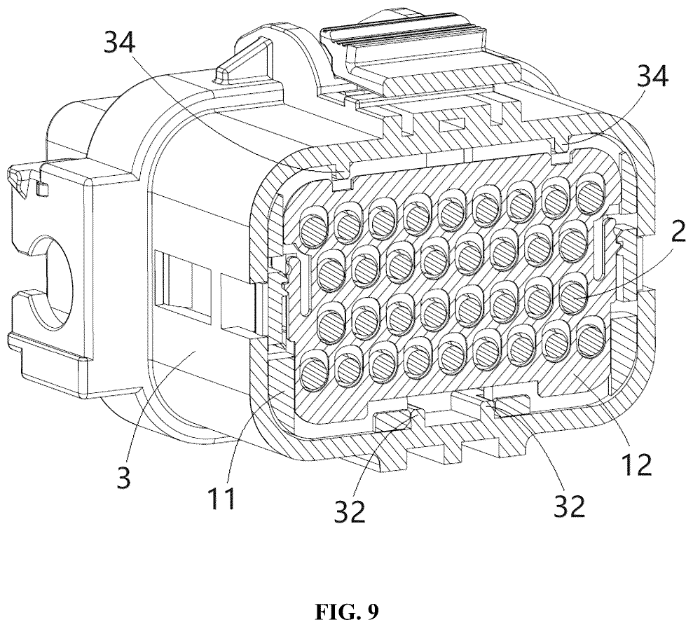

As shown in FIG. 5, in the illustrated embodiment, a pair of guide slots 114 are formed on the upper side of the fixing component 11, and the upper slot 113 is located between the pair of guide slots 114. The pair of guide slots 114 are used to cooperate with a pair of upper guide ribs 34 on the housing 3, as shown in FIGS. 1 and 9, to guide the fixing component 11 to be inserted into the installation port 30 of the housing 3 along the axial direction Y of the cable hole 101.

As shown in FIGS. 1-12, in the illustrated embodiment, the fixing component 11 is in the shape of a plate with a predetermined thickness, the slot 111 extends radially along the cable hole 101, and the locking component 12 cooperates with the slot 111.

As shown in FIGS. 1-12, in the illustrated embodiment, multiple cable holes 101 are arranged in multiple rows and columns.

The connector housing assembly is now described in more detail in reference to FIGS. 1-12. The connector housing assembly comprises the housing 3 and the cable fixing device 1. The housing 3, as shown in FIGS. 1-3, 9, and 12, has the installation port 30. The cable fixing device 1 is installed into the installation port 30 of the housing 3.

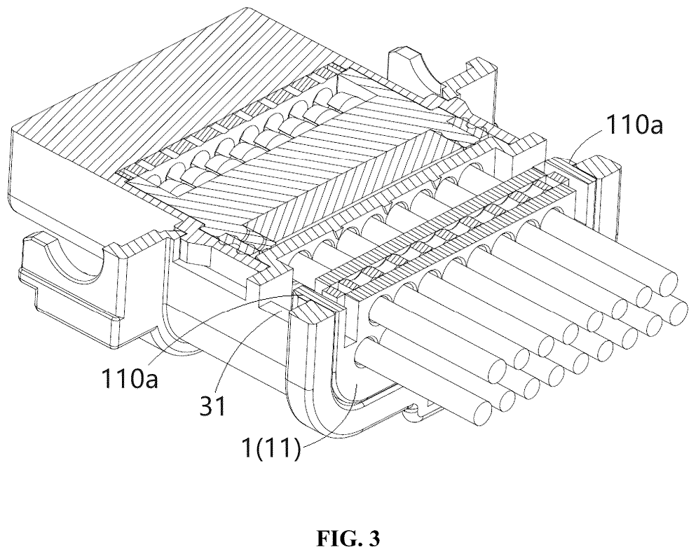

As shown in FIGS. 1 and 3, in the illustrated embodiment, locking slots 31 are formed on the left and right inner wall surfaces of the installation port 30 of the housing 3, respectively. The locking slots 31 are used to engage with the elastic locking buckles 110 on the fixing component 11 of the cable fixing device 1 to lock the cable fixing device 1 in the installation port 30 of the housing 3.

As shown in FIG. 1, in the illustrated embodiment, the locking slot 31 has a locking surface 31a perpendicular to the axial direction Y of the cable hole 101, and the protruding portions 110a on the elastic locking buckle 110 is pressed against the locking surface 31a to prevent the cable fixing device 1 from being pulled out from the installation port 30 of the housing 3.

As shown in FIGS. 1 and 9, in the illustrated embodiment, a pair of lower guide ribs 32 are formed on the inner wall surface of the lower side of the installation port 30 of the housing 3. The outer side of the pair of lower guide ribs 32 is adapted to be pressed against the inner side of the lower slot 112 of the fixing component 11 to guide the fixing component 11 to be inserted into the installation port 30 of the housing 3 along the axial direction Y of the cable hole 101.

As shown in FIG. 1, in the illustrated embodiment, a pair of positioning protrusions 33 are also formed on the inner wall surface of the lower side of the installation port 30 of the housing 3, and the pair of positioning protrusions 33 are respectively connected to the pair of lower guide ribs 32. The fixing component 11, as shown in FIGS. 1 and 5, has front and rear sides opposite to each other in the axial direction Y of the cable hole 101. The positioning protrusion 33 has a positioning surface 33a, as shown in FIG. 1, perpendicular to the axial direction Y of the cable hole 101, which is pressed against a front side of the fixing component 11 to position the fixing component 11 in the axial direction Y.

As shown in FIGS. 1 and 9, in the illustrated embodiment, a pair of upper guide ribs 34 are formed on the inner wall surface of the upper side of the installation port 30 of the housing 3. The pair of upper guide ribs 34 extend along the axial direction Y of the cable hole 101 and are adapted to cooperate with a pair of guide slots 114 on the fixing component 11 to guide the fixing component 11 to be inserted into the installation port 30 of the housing 3 along the axial direction Y of the cable hole 101.

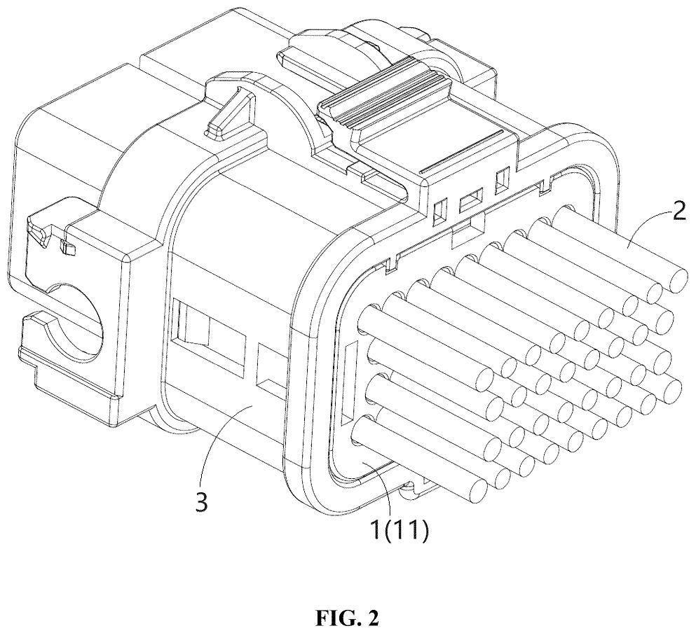

As shown in FIGS. 1 and 5, in the illustrated embodiment, the fixing component 11 has front and rear sides opposite to each other in the axial direction Y of the cable hole 101, and the housing 3 has front and rear ends opposite to each other in the axial direction Y of the cable hole 101. When the cable fixing device 1 is installed into the installation port 30 of the housing 3, as shown in FIGS. 2-3, 9, and 12, the rear side of the fixing component 11 is flush with the a rear end face of the housing 3.

The connector is now described in more detail in reference to FIGS. 1-12. The connector, as described above, comprises the connector housing assembly, the multiple terminals, and the multiple cables 2. The multiple terminals are provided in the housing 3. The multiple cables 2 are electrically connected to the multiple terminals. The multiple cables 2 pass through the multiple cable holes 101 of the fixing component 11 and are locked to the fixing component 11 by the locking component 12. In this way, the amount of shaking of the cable 2 can be reduced, ensuring that the position of the terminal does not move and ensuring reliable electrical contact between the terminal and a mating terminal.

As shown in FIGS. 1-3, 8-9, and 11-12, in the illustrated embodiment, the multiple cables 2 are arranged in multiple rows and columns.

In the aforementioned exemplary embodiments according to the present invention, the cable fixing device has a simple structure, reduces costs, and can be used to fix multiple rows and columns of cables, expanding its application range.

It should be appreciated for those skilled in this art that the above embodiments are intended to be illustrated, and not restrictive. For example, many modifications may be made to the above embodiments by those skilled in this art, and various features described in different embodiments may be freely combined with each other without conflicting in configuration or principle.

Although several exemplary embodiments have been shown and described, it would be appreciated by those skilled in the art that various changes or modifications may be made in these embodiments without departing from the principles and spirit of the disclosure, the scope of which is defined in the claims and their equivalents.

As used herein, an element recited in the singular and preceded with the word “a” or “an” should be understood as not excluding plural of said elements or steps, unless such exclusion is explicitly stated. Furthermore, references to “one embodiment” of the present invention are not intended to be interpreted as excluding the existence of additional embodiments that also incorporate the recited features. Moreover, unless explicitly stated to the contrary, embodiments “comprising” or “having” an element or a plurality of elements having a particular property may include additional such elements not having that property.

1. A cable fixing device, comprising:
a fixing component having a plurality of cable holes and a slot transversely running through the plurality of cable holes; and
a locking component having a plurality of slot holes corresponding to the plurality of cable holes, the locking component is inserted into the slot of the fixing component and is movable between a pre-lock position and a final-lock position, one of the slot holes aligns with one of the cable holes and a cable is passable through the one of the cable holes and the one of the slot holes in the pre-lock position, the one of the slot holes is offset from the one of the cable holes in the final-lock position and an inner wall surface of the one of the slot holes presses against the cable passing through the one of the cable holes to lock the cable.

2. The cable fixing device of claim 1, wherein the fixing component and the locking component both have an upper side and a lower side opposite each other in a first direction perpendicular to an axial direction of the one of the cable holes, the slot has an upper opening located on the upper side of the fixing component, and the locking component is inserted into the slot along the first direction through the upper opening.

3. The cable fixing device of claim 2, wherein the fixing component and the locking component each have a left side and a right side opposite each other in a second direction perpendicular to the first direction and the axial direction of the one of the cable holes, a plurality of elastic buckles with a plurality of locking protrusions are respectively formed on the left side and the right side of the locking component, and a first protrusion, a second protrusion, and a snap slot located between the first protrusion and the second protrusion are respectively formed on each of the left side and the right side of the slot of the fixing component.

4. The cable fixing device of claim 3, wherein one of the locking protrusions on one of the elastic buckles engages with the snap slot to hold the locking component in the pre-lock position, the one of the locking protrusions on the one of the elastic buckles engages with the second protrusion to hold the locking component in the final-lock position.

5. The cable fixing device of claim 4, wherein each of the slot holes of the locking component has a size and an elliptical shape, the size of the slot hole in the first direction is larger than the size of the slot hole in the second direction, a diameter of each of the cable holes is equal to or larger than a diameter of the cable, the size of the slot hole in the second direction is equal to or larger than the diameter of the cable.

6. The cable fixing device of claim 5, wherein the fixing component is installed into an installation port of a housing, and a plurality of elastic locking buckles each having a protrusion are respectively formed on the left side and the right side of the fixing component, the protrusions of the elastic locking buckles engage with a plurality of locking slots on the housing to lock the fixing component into the installation port of the housing.

7. The cable fixing device of claim 6, wherein an upper slot and a lower slot are respectively formed on the upper side and the lower side of the fixing component to receive an operating tool, the locking component is movable from the pre-lock position to the final-lock position by the operating tool inserted into the upper slot or from the final-lock position to the pre-lock position by the operating tool inserted into the lower slot.

8. The cable fixing device of claim 7, wherein a pair of inner sides of the lower slot of the fixing component are perpendicular to the second direction and rest on a pair of outer sides of a pair of lower guide ribs of the housing to guide the fixing component into the installation port of the housing along the axial direction.

9. The cable fixing device of claim 7, wherein a pair of guide slots are formed on the upper side of the fixing component, the upper slot is located between the pair of guide slots, the pair of guide slots cooperate with a pair of upper guide ribs on the housing to guide the fixing component into the installation port of the housing along the axial direction.

10. The cable fixing device of claim 1, wherein the fixing component is a plate with a predetermined thickness, the slot extends along a radial direction of the one of the cable holes.

11. The cable fixing device of claim 1, wherein the plurality of cable holes are arranged in a plurality of rows and a plurality of columns.

12. A connector housing assembly, comprising:
a cable fixing device having a fixing component and a locking component, the fixing component has a plurality of cable holes and a slot transversely running through the plurality of cable holes, the locking component has a plurality of slot holes corresponding to the plurality of cable holes, the locking component is inserted into the slot of the fixing component and is movable between a pre-lock position and a final-lock position, one of the slot holes aligns with one of the cable holes and a cable is passable through the one of the cable holes and the one of the slot holes in the pre-lock position, the one of the slot holes is offset from the one of the cable holes in the final-lock position and an inner wall surface of the one of the slot holes is pressed against the cable passing through the one of the cable holes to lock the cable; and
a housing having an installation port, the cable fixing device is installed into the installation port of the housing.

13. The connector housing assembly of claim 12, wherein a plurality of locking slots are respectively formed on a left inner wall and a right inner wall of the installation port of the housing, the locking slots engage a plurality of elastic locking buckles on the fixing component to lock the cable fixing device in the installation port.

14. The connector housing assembly of claim 13, wherein each of the locking slots has a locking surface perpendicular to an axial direction of the one of the cable holes, a protrusion portion formed on the elastic locking buckles rests against the locking surface to prevent the cable fixing device from being pulled out from the installation port of the housing.

15. The connector housing assembly of claim 12, wherein a pair of lower guide ribs are formed on an inner wall surface of a lower side of the installation port of the housing, a pair of outer sides of the pair of lower guide ribs are pressed against an inner side of a lower slot of the fixing component to guide the fixing component into the installation port of the housing along an axial direction of the one of the cable holes.

16. The connector housing assembly of claim 15, wherein a pair of positioning protrusions are formed on the inner wall surface of the lower side of the installation port, the pair of positioning protrusions are respectively connected to the pair of lower guide ribs, the fixing component has a front side and a rear side opposite each other in the axial direction, each of the positioning protrusions has a positioning surface perpendicular to the axial direction, the positioning surface is pressed against a front side of the fixing component to position the fixing component in the axial direction.

17. The connector housing assembly of claim 12, wherein a pair of upper guide ribs are formed on an inner wall surface of an upper side of the installation port, the pair of upper guide ribs extend along an axial direction of the one of the cable holes and cooperate with a pair of guide slots on the fixing component to guide the fixing component into the installation port along the axial direction.

18. The connector housing assembly of claim 12, wherein the fixing component has a front side and a rear side opposite each other in an axial direction of the one of the cable holes, the housing has a front end and a rear end opposite each other in the axial direction, the rear side of the fixing component is flush with a rear end face of the housing when the cable fixing device is installed into the installation port.

19. A connector, comprising:
a plurality of terminals;
a plurality of cables electrically connected to the plurality of terminals; and
a connector housing assembly, comprising:
a cable fixing device having a fixing component and a locking component, the fixing component has a plurality of cable holes and a slot transversely running through the plurality of cable holes, the locking component has a plurality of slot holes corresponding to the plurality of cable holes, the locking component is inserted into the slot of the fixing component and is movable between a pre-lock position and a final-lock position, one of the slot holes aligns with one of the cable holes and one of the cables passes through the one of the cable holes and the one of the slot holes, the one of the slot holes is offset from the one of the cable holes in the final-lock position and an inner wall surface of the one of the slot holes is pressed against the one of the cables passing through the one of the cable holes to lock the one of the cables; and
a housing in which the plurality of terminals are disposed, the housing has an installation port, the cable fixing device is installed into the installation port of the housing.

20. The connector of claim 19, wherein the plurality of cables are arranged in a plurality of rows and a plurality of columns.
